(19) United States
(12) Patent Application Publication
(10) Pub. No.: US 2007/0257652 A1
(43) Pub. Date: Nov. 8, 2007

(54) Booster Circuit with Protection Function and Electric Device

(75) Inventor: Daiki Yanagishima, Kyoto (JP)

Correspondence Address: FISH & RICHARDSON P.C., P.O. BOX 1022, MINNEAPOLIS, MN, 55440-1022, US

(73) Assignee: ROHM CO., LTD., Kyoto (JP)

(21) Appl. No.: 11/739,269

(22) Filed: Apr. 24, 2007

(30) Foreign Application Priority Data
May 2, 2006 (JP) 2006-128212

(51) Int. Cl. G05F 1/00

(52) U.S. Cl. 323/284

(57) ABSTRACT

An electric device includes a booster circuit. When a switch control circuit detects abnormal lowering of a second voltage provided from the booster circuit while the booster circuit is boosting a first voltage, the switch control circuit changes a switch from an on state to an off state. This cuts off electrical connection between an anode of a diode and a power supply node. For example, when a second node is grounded, the second voltage lowers. At this time, the switch control circuit changes the switch from the on state to the off state. This can prevent flow of an excessive current through the diode when the second node is grounded. Therefore, the booster circuit with a protection function as well as the electric device with this booster circuit can be provided.

### BACKGROUND OF THE INVENTION

1. Field of the Invention

The present invention relates to a booster circuit and an electric device, and particularly to a booster circuit having a protection function as well as an electric device provided with the booster circuit.

2. Description of the Background Art

FIG. 10 is a circuit diagram showing a structure of a conventional booster circuit.

Referring to FIG. 10, a booster circuit 102 includes a main unit 106, capacitors C1 and C2, and a clock circuit 105. Main unit 106 includes diodes D1 and D2, and a level shift circuit 107. Booster circuit 102 shown in FIG. 10 is generally referred to as a charge pump circuit.

Main unit 106 further has terminals T1, T2, CP1 and CP2. Terminal T1 is connected to a power supply node. Terminal T1 is supplied with a voltage VCC. The “voltage” represents a potential difference with respect to a ground potential unless otherwise specified.

Capacitor C1 is connected between terminals T1 and T2. Capacitor C2 is connected between terminals CP1 and CP2.

Diode D1 has an anode and a cathode connected to terminals T1 and CP2, respectively. Diode D2 has an anode and a cathode connected to terminals CP2 and T2, respectively.

Level shift circuit 107 receives a clock signal from clock circuit 105. Level shift circuit 107 converts a voltage (e.g., 3 V) of the received clock signal to a higher voltage (e.g., 15 V), and provides the converted signal to terminal CP1.

When level shift circuit 107 provides a voltage, e.g., of 15 V, terminal CP2 attains the voltage of (VCC+15−ΔV1) volts, where ΔV1 represents a forward voltage (about 0.7 V) of diode D1. A voltage VG on terminal T2 is lower by a forward voltage (about 0.7 V) of diode D2 than the voltage on terminal CP2. Assuming that ΔV2 represents the forward voltage of diode D2, voltage VG becomes equal to (VCC+15−ΔV1−ΔV2). Therefore, voltage VG is higher than voltage VCC. Voltage VG is supplied to the load (not shown).

Capacitor C1 functions to smoothen voltage VG. Therefore, voltage VG is kept higher than voltage VCC.

For example, Japanese Patent Laying-Open No. 2002-204569 has disclosed a switching power supply provided with a charge pump circuit. This switching power supply adjusts a voltage supplied from a battery to attain a predetermined magnitude. Also, the switching power supply boosts the adjusted input voltage by a predetermined gain rate to provide a desired voltage.

In booster circuit 102 shown in FIG. 10, an excessive current flows through diodes D1 and D2, e.g., when terminal T2 (terminal CP2) is short-circuited. This may damage diodes D1 and D2. Japanese Patent Laying-Open No. 2002-204569 has not disclosed a manner of protecting a charge pump circuit when an output voltage lowers due to, e.g., grounding of an output terminal of the charge pump circuit.

### SUMMARY OF THE INVENTION

An object of the invention is to provide a booster circuit having a protection function as well as an electric device with this booster circuit.

In summary, a booster circuit of the invention includes a booster, a switch and a control circuit. The booster boosts a first voltage supplied from a voltage power supply to a first node, and provides the boosted first voltage as a second voltage to a second node. The switch is arranged between the voltage power supply and the first node, and is on at least during an operation of the booster. The control circuit monitors the second voltage during the operation of the booster, and changes the switch from an on state to an off state when the control circuit detects abnormal lowering of the second voltage.

Preferably, the control circuit includes a detecting unit and a switch setting circuit. The detecting unit provides a first detection result indicative of detection of the abnormal lowering when the second voltage becomes lower than a first threshold voltage. The switch setting circuit starts measurement of an elapsed time according to the first detection result, and changes the switch from the on state to the off state when the elapsed time exceeds a predetermined time.

More preferably, the switch setting circuit stops the measurement of the elapsed time and keeps the switch in the on state when the second voltage rises to or above the first threshold voltage before the elapsed time exceeds the predetermined time.

More preferably, the detecting unit provides a second detection result when the detecting unit detects that the second voltage becomes lower than a second threshold voltage lower than the first threshold voltage. The switch setting circuit turns off the switch when the switch setting circuit receives the second detection result before the elapsed time exceeds the predetermined time.

Further preferably, the booster circuit further includes a first capacitor connected between the voltage power supply and the second node, and a second capacitor connected between third and fourth nodes. The booster includes a first diode having an anode and a cathode connected to the first and third nodes, respectively, a second diode having an anode and a cathode connected to the third and second nodes, respectively, and a level shift circuit receiving a clock signal, changing an amplitude of the clock signal, and outputting the clock signal to the fourth node. The detecting unit includes a first voltage divider circuit dividing the first voltage to produce a first comparison voltage, a second voltage divider circuit dividing a third voltage on the third node to produce a second comparison voltage, a third voltage divider circuit dividing the second voltage to produce a third comparison voltage, a first comparator making a comparison between the first and second comparison voltages to provide a result of the comparison as the first detection result, and a second comparator making a comparison between the first and third comparison voltages to provide a result of the comparison as the second detection result.

More preferably, the first threshold voltage is lower than the second voltage appearing at a start of an operation of the booster.

According to another aspect of the invention, an electric device includes a booster circuit. The booster circuit includes a booster, a switch and a control circuit. The booster boosts a first voltage supplied from a voltage power supply to a first node, and provides the boosted first voltage as a second voltage to a second node. The switch is arranged between the voltage power supply and the first node, and is on at least during an operation of the booster. The control circuit monitors the second voltage during the operation of the booster, and changes the switch from an on state to an off state when the control circuit detects abnormal lowering of the second voltage.

Preferably, the control circuit includes a detecting unit and a switch setting circuit. The detecting unit provides a first detection result indicative of detection of the abnormal lowering when the second voltage becomes lower than a first threshold voltage. The switch setting circuit starts measurement of an elapsed time according to the first detection result, and changes the switch from the on state to the off state when the elapsed time exceeds a predetermined time.

More preferably, the switch setting circuit stops the measurement of the elapsed time and keeps the switch in the on state when the second voltage rises to or above the first threshold voltage before the elapsed time exceeds the predetermined time.

More preferably, the detecting unit provides a second detection result when the detecting unit detects that the second voltage becomes lower than a second threshold voltage lower than the first threshold voltage. The switch setting circuit turns off the switch when the switch setting circuit receives the second detection result before the elapsed time exceeds the predetermined time.

Further preferably, the booster circuit further includes a first capacitor connected between the voltage power supply and the second node, and a second capacitor connected between third and fourth nodes. The booster includes a first diode having an anode and a cathode connected to the first and third nodes, respectively, a second diode having an anode and a cathode connected to the third and second nodes, respectively, and a level shift circuit receiving a clock signal, changing an amplitude of the clock signal and outputting the clock signal to the fourth node. The detecting unit includes a first voltage divider circuit dividing the first voltage to produce a first comparison voltage, a second voltage divider circuit dividing a third voltage on the third node to produce a second comparison voltage, a third voltage divider circuit dividing the second voltage to produce a third comparison voltage, a first comparator making a comparison between the first and second comparison voltages to provide a result of the comparison as the first detection result, and a second comparator making a comparison between the first and third comparison voltages to provide a result of the comparison as the second detection result.

More preferably, the first threshold voltage is lower than the second voltage appearing at a start of an operation of the booster.

Accordingly, a major advantage of the invention is that damage to the booster circuit can be prevented when abnormality such as grounding of the output terminal occurs.

As another advantage, the invention can improve operation reliability of the electric device.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram of an electric device with a booster circuit of an embodiment.

FIG. 2 is a circuit diagram showing a structure of a booster circuit 2 in FIG. 1.

FIG. 3 shows a specific example of a structure of a switch SW in FIG. 2.

FIG. 4 is a flowchart schematically illustrating a control operation of switch SW performed by a switch control circuit 8 shown in FIG. 2.

FIG. 5 is a circuit diagram showing an example of a structure of switch control circuit 8 shown in FIG. 2.

FIG. 6 is a waveform diagram illustrating an operation performed when switch SW is on in booster circuit 2 shown in FIG. 2.

FIG. 7 is a waveform diagram illustrating an operation performed by switch control circuit 8 in FIG. 5 when a voltage VG in FIG. 2 abnormally lowers.

FIG. 8 is another waveform diagram illustrating an operation performed by switch control circuit 8 in FIG. 5 when voltage VG lowers.

FIG. 9 illustrates an operation waveform appearing when booster circuit 2 in FIG. 2 starts the operation.

FIG. 10 is a circuit diagram showing a structure of a conventional booster circuit.

### DESCRIPTION OF THE PREFERRED EMBODIMENTS

Embodiments of the invention will now be described with reference to the drawings. In the following description and drawings, the same or corresponding portions bear the same reference numbers.

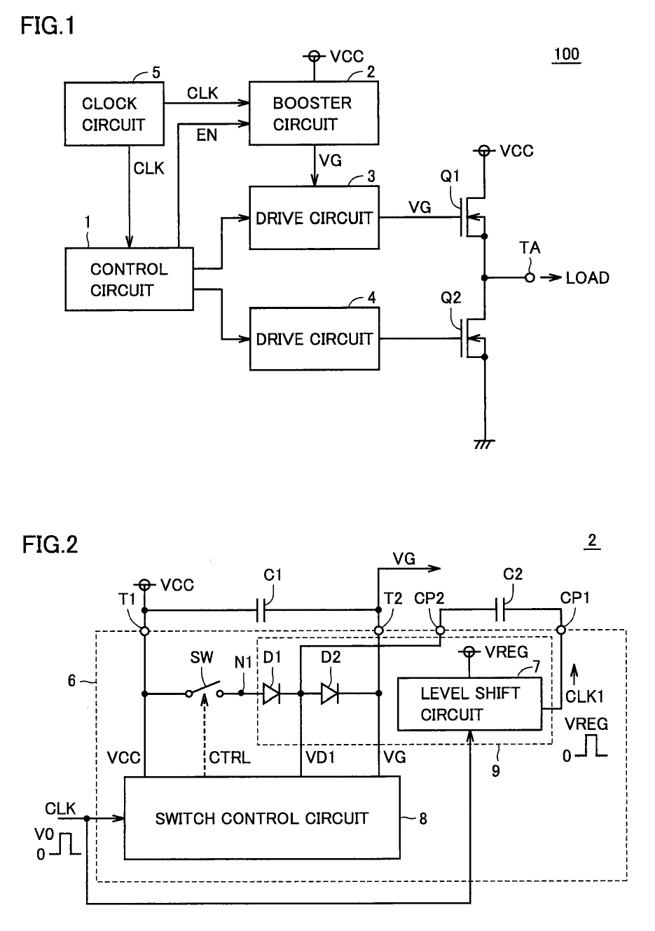

FIG. 1 is a schematic block diagram of an electric device provided with a booster circuit of the embodiment.

Referring to FIG. 1, an electric device 100 includes N-channel MOS transistors Q1 and Q2, a control circuit 1, a booster circuit 2, drive circuits 3 and 4, and a clock circuit 5.

N-channel MOS transistor Q1 has a drain connected to a power supply node, and receives on its drain a voltage VCC, e.g., of 50 V. Also, N-channel MOS transistor Q1 has a source connected to a terminal TA, and has a gate receiving a drive signal provided from drive circuit 3.

N-channel MOS transistor Q2 has a drain connected to terminal TA as well as a source connected to a ground node. N-channel MOS transistor Q2 receives on its gate a drive signal provided from drive circuit 4.

Terminal TA is connected to a load, which is, e.g., a coil of a motor, a coil of a switching power supply or the like.

When N-channel MOS transistor Q1 is on and N-channel MOS transistor Q2 is off, the voltage on terminal TA is substantially equal to voltage VCC. For turning on N-channel MOS transistor Q1, it is necessary that a voltage VG placed on the gate of N-channel MOS transistor Q1 is higher than the voltage of terminal TA (nearly equal to voltage VCC) by a threshold voltage of N-channel MOS transistor Q1.

Booster circuit 2 boosts voltage VCC to voltage VG, e.g., of 60 V, and supplies voltage VG as the power supply voltage to drive circuit 3. When control circuit 1 provides a signal to drive circuit 3, drive circuit 3 changes the voltage level (e.g., of several volts) of the input signal to the level of voltage VG, and outputs it. Thereby, N-channel MOS transistor Q1 receives voltage VG on its gate. Control circuit 1 provides a signal at a voltage level of several volts to drive circuit 4. Drive circuit 4 outputs a signal, e.g., at the same voltage level as the input signal, and thereby drives N-channel MOS transistor Q2.

Clock circuit 5 produces a clock signal CLK, and provides it to control circuit 1 and booster circuit 2. Clock signal CLK serves as a reference of operations of control circuit 1 and booster circuit 2.

Control circuit 1 transmits a signal EN to booster circuit 2. When signal EN at an H-level, e.g., of 3 V, booster circuit 2 operates. When signal EN is at an L-level, e.g., of 0 V, booster circuit 2 stops.

FIG. 2 is a circuit diagram showing a structure of booster circuit 2 in FIG. 1.

Referring to FIG. 2, booster circuit 2 includes capacitors C1 and C2, and a main unit 6. Main unit 6 is, e.g., one semiconductor integrated circuit.

Main unit 6 has terminals T1, T2, CP1 and CP2. Capacitor C1 is connected between terminals T1 and T2. Capacitor C2 is connected between terminals CP1 and CP2.

Main unit 6 includes a booster 9, a switch SW and a switch control circuit 8. Booster 9 includes diodes D1 and D2 as well as a level shift circuit 7. Booster 9 and capacitors C1 and C2 form a so-called “charge pump circuit”.

Terminal T1 receives voltage VCC from a power supply node (voltage supply). Booster 9 boosts voltage VCC to provide voltage VG to terminal T2. Switch SW is connected between terminal T1 and an anode (node N1) of diode D1. Switch SW receives a signal CTRL from switch control circuit 8, and performs switching between on and off states.

Diode D1 has a cathode connected to terminal CP2. Diode D2 has an anode and a cathode connected to terminals CP2 and T2, respectively.

Level shift circuit 7 receives clock signal CLK, and provides a clock signal CLK1 to terminal CP1. The voltage of clock signal CLK changes between zero and a voltage V0. The voltage of clock signal CLK1 changes between zero and a voltage VREG, which is higher than voltage V0. In this manner, level shift circuit 7 changes an amplitude of clock signal CLK.

Switch control circuit 8 receives voltages VCC, VD1 and VG, and controls on and off of switch SW. For turning on switch SW, switch control circuit 8 sets signal CTRL to the H-level. For turning off switch SW, switch control circuit 8 sets signal CTRL to the L-level.

When abnormal lowering of voltage VG is detected during the boosting of voltage VCC by booster 9, switch control circuit 8 changes switch SW from the on state to the off state. Thereby, the anode of diode D1 is electrically cut off from the power supply node. For example, when terminal T2 (or terminal CP2) is grounded, voltages VG and VD1 lower. At this time, switch control circuit 8 changes switch SW from the on state to the off state. This can prevent flowing of excessive currents through diodes D1 and D2 when terminal T2 (or terminal CP2) is grounded.

Switch control circuit 8 receives signal EN. When signal EN is at the H-level, switch control circuit 8 performs the foregoing operation of controlling switch SW. When signal EN is at the L-level, switch control circuit 8 always sets signal CTRL at the L-level to keep switch SW in the off state.

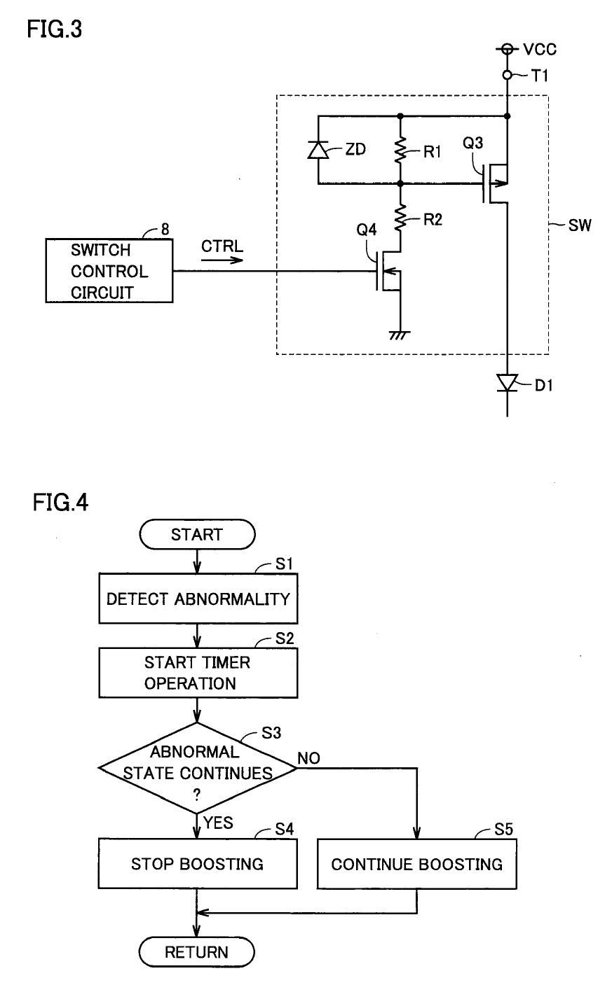

FIG. 3 shows an example of a specific structure of switch SW in FIG. 2.

Referring to FIG. 3, switch SW includes a P-channel MOS transistor Q3, an N-channel MOS transistor Q4, resistances R1 and R2, and a Zener diode ZD.

P-channel MOS transistor Q3 has a source and a drain connected to terminal T1 and an anode of diode D1, respectively.

One of ends of resistance R1 and a cathode of Zener diode ZD are connected to terminal T1. The other end of resistance R1 and an anode of Zener diode ZD are connected to a gate of P-channel MOS transistor Q3.

Resistance R2 is connected between a gate of P-channel MOS transistor Q3 and a drain of N-channel MOS transistor Q4. N-channel MOS transistor Q4 has a source connected to a ground node, and receives signal CTRL provided from switch control circuit 8 on its gate.

When signal CTRL is at the H-level, N-channel MOS transistor Q4 is turned on. Therefore, the voltage on the gate of P-channel MOS transistor Q3 becomes lower than voltage VCC. In this state, since a difference between the voltage on the gate of P-channel MOS transistor Q3 and voltage VCC is larger than a threshold voltage of P-channel MOS transistor Q3, P-channel MOS transistor Q3 is turned on. Therefore, the power supply node is electrically connected to the anode of diode D1.

When signal CTRL is at the L-level, N-channel MOS transistor Q4 is off. Since the voltage on the gate of P-channel MOS transistor Q3 becomes equal to voltage VCC, P-channel MOS transistor Q3 is off. Therefore, the power supply node is electrically cut off from the anode of diode D1.

Switch control circuit 8 shown in FIG. 2 will now be described in greater detail.

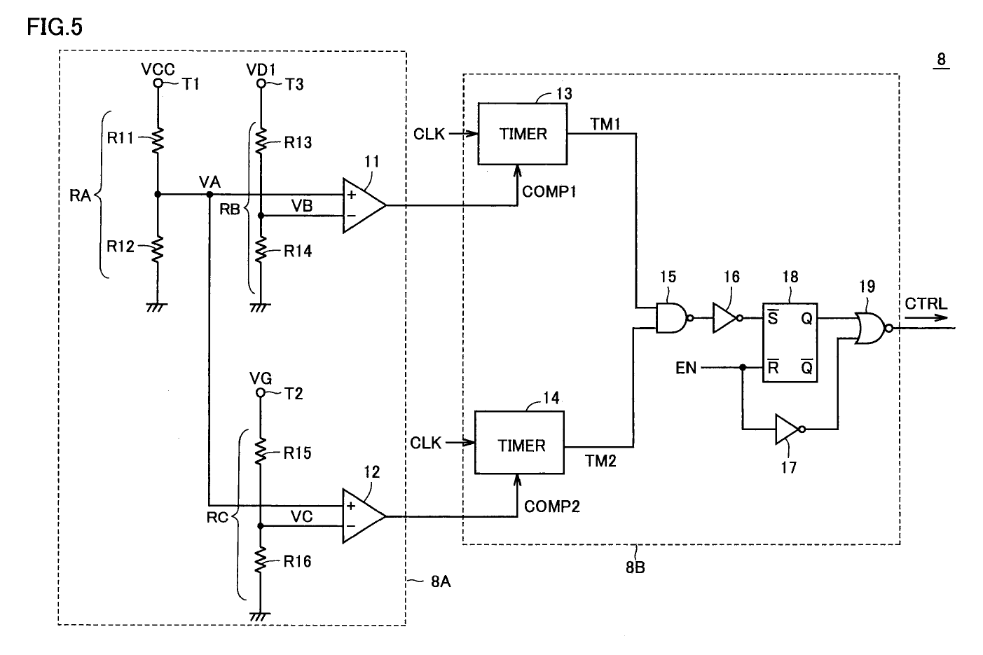

FIG. 4 is a flowchart schematically illustrating a control operation for switch SW performed by switch control circuit 8 shown in FIG. 2.

Referring to FIGS. 4 and 2, when processing starts, switch control circuit 8 first detects abnormality in voltage VG in step S1. The abnormality in voltage VG means that voltage VG becomes lower than a certain threshold voltage (first threshold voltage).

In next step S2, switch control circuit 8 measures, based on clock signal CLK, a time elapsed since voltage VG becomes lower than the first threshold voltage. Thus, switch control circuit 8 performs a timer operation.

In next step S3, switch control circuit 8 determines whether the state in which voltage VG is abnormal has continued for a predetermined time or not. When the elapsed time exceeds the predetermined time, switch control circuit 8 determines that the abnormal state of voltage VG is continuing. In this case (YES in step S3), switch control circuit 8 changes the level of a signal CTLR from the H-level to the L-level in step S4, and thereby turns off switch SW. Therefore, voltage VCC is not supplied to the anode of diode D1. Thus, booster circuit 2 stops the boosting operation in step S4.

Even when the operation of electric device 100 shown in FIG. 1 is normal, voltage VG may lower instantaneously due to a certain factor. In this case, switch control circuit 8 likewise executes the processing of steps S1 and S2. When switch control circuit 8 detects that voltage VG rises to or above the first threshold during the time measurement, it determines that the abnormal state ends. In this case (NO in step S3), switch control circuit 8 stops the measurement of the elapsed time, and controls switch SW to continue the on state.

When the processing in steps S4 or S5 ends, the whole processing returns to step S1.

In summary, switch control circuit 8 turns off switch SW only when voltage VG continuously keeps the level lower than the first threshold voltage for a certain time. Since switch control circuit 8 controls switch SW as described above, switch control circuit 8 can correctly detect the abnormal state.

FIG. 5 is a circuit diagram showing an example of a structure of switch control circuit 8 shown in FIG. 2.

Referring to FIG. 5, switch control circuit 8 includes a detecting unit 8A and a timer latch circuit 8B. The timer latch circuit corresponds to the “switch setting circuit” in the invention.

Detecting unit 8A includes resistance voltage divider circuits RA, RB and RC, and comparators 11 and 12. Resistance voltage divider circuit RA includes resistances R11 and R12, which are connected in series between terminal T1 and the ground node. Resistances R11 and R12 divide voltage VCC to generate a voltage VA (first comparison voltage).

Resistance voltage divider circuit RB includes resistances R13 and R14, which are connected in series between terminal T3 and the ground node. Resistances R13 and R14 divide voltage VD1 to generate a voltage VB (second comparator voltage).

Resistance voltage divider circuit RC includes resistances R15 and R16, which are connected in series between terminal T2 and the ground node. Resistances R15 and R16 divide voltage VG to generate a voltage VC (third comparison voltage).

Comparator 11 makes a comparison between voltages VA and VB to provide a signal COMP1. When voltage VA is smaller than voltage VB, signal COMP1 is at the L-level. When voltage VA is larger than voltage VB, signal COMP1 is at the H-level. Voltage VA is larger than voltage VB when voltage VG is lower than the first threshold voltage.

Comparator 12 makes a comparison between voltages VA and VC to provide a signal COMP2. When voltage VA is smaller than voltage VC, signal COMP2 is at the L-level. When voltage VA is larger than voltage VC, signal COMP2 is at the H-level. Voltage VA is larger than voltage VC when voltage VG is lower than the second threshold voltage. The second threshold voltage is lower than the first threshold voltage.

Timer latch circuit 8B includes timers 13 and 14, NAND circuit 15, inverters 16 and 17, an RS latch 18 and an NOR circuit 19.

Timer 13 becomes active in response to reception of signal COMP1 at the H-level, and thereby switches a signal TM1 between the H- and L-levels in a cycle equal to an integral multiple of a period of clock signal CLK. Timer 14 becomes active in response to reception of signal COMP2 at the H-level, and thereby switches a signal TM2 between the H- and L-levels in a cycle equal to an integral multiple of the period of clock signal CLK.

For example, each of timers 13 and 14 is a frequency divider, and may have the same division ratio as the other.

Timers 13 and 14 are deactivated in response to reception of signals COMP1 and COMP2, respectively. Thus, each of timers 13 and 14 stops time measurement when it receives corresponding signal COMP1 or COMP2 at the L-level.

NAND circuit 15 receives signals TM1 and TM2. Inverter 16 inverts the signal provided from NAND circuit 15, and outputs the inverted signal.

Inverter 17 inverts signal EN provided from control circuit 1 in FIG. 1, and outputs the inverted signal. As described above, signal EN is always at the H-level while switch control circuit 8 is operating.

RS latch 18 receives on its terminal /S the signal provided from inverter 16, and receives on its terminal /R signal EN, where “/” represents inversion. NOR circuit 19 receives a signal provided from a terminal Q of RS latch 18 and a signal provided from inverter 17, and outputs signal CTRL.

Operations of detecting unit 8A and timer latch circuit 8B shown in FIG. 3 will now be described schematically. When detecting unit 8A detects that voltage VG becomes lower than the first threshold voltage, it provides signal COMP1 (i.e., a first detection result) at the H-level. Timer latch circuit 8B starts measurement of the elapsed time in response to signal COMP1 at the H-level. When the elapsed time exceeds a predetermined time, timer latch circuit 8B changes switch SW shown in FIG. 2 from the on state to the off state.

Further, when voltage VG rises to or above the first threshold voltage before the elapsed time exceeds the predetermined time, timer latch circuit 8B receives signal COMP1 at the L-level. In this case, timer latch circuit 8B stops measurement of the elapsed time, and keeps switch SW in the on state.

Further, detecting unit 8A provides signal COMP2 (second detection result) at the H-level when it detects that voltage VG becomes lower than the second threshold voltage lower than the first threshold voltage. Timer latch circuit 8B turns off switch SW when it receives signal COMP2 at the H-level before the elapsed time exceeds the predetermined time.

Operations of booster circuit 2 of this embodiment will now be described in greater detail. First, description will be given on an operation performed when booster circuit 2 is normal. Then, description will be given on an operation of switch control circuit 8 performed when voltage VG lowers.

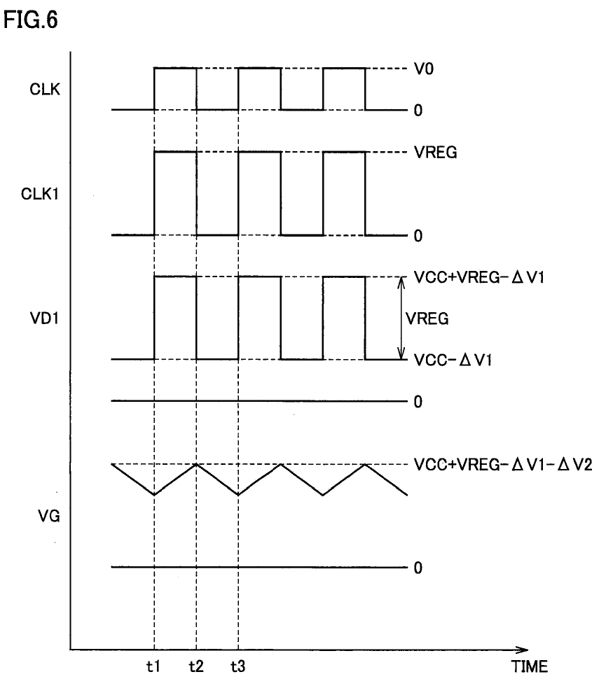

FIG. 6 is a waveform diagram illustrating an operation performed when switch SW is on in booster circuit 2 in FIG. 2.

Referring to FIGS. 6 and 2, the voltage of clock signal CLK changes from zero to voltage V0 at time t1. At time t1, the voltage of clock signal CLK1 also changes from zero to voltage VREG in response to change in voltage of clock signal CLK. For example, voltage V0 is 3 V, and voltage VREG is 15 V.

Before time t1, voltage VD1 on terminal CP2 is equal to (VCC−ΔV1) where ΔV1 represents the forward voltage of diode D1, and is about 0.7 V. Since capacitor C2 is connected between terminals CP1 and CP2, level shift circuit 7 changes the voltage on terminal CP1, and thereby changes the voltage on terminal CP2.

Thereby, voltage VD1 on terminal CP2 changes from a voltage (VCC−ΔV1) to a voltage (VCC+VREG−ΔV1) at time t1. Thus, voltage VD1 rises a magnitude of voltage VREG from voltage (VCC−ΔV 1) at time t1.

During a period between times t1 and t2, the voltages of clock signals CLK and CLK1 do not change from the voltages attained at time t1. Likewise, during the period between times t1 and t2, voltage VD1 does not change from the voltage attained at time t1. However, voltage VG rises during the period between times t1 and t2. At time t2, voltage VG becomes equal to (VCC+VREG−ΔV1−ΔV2), where ΔV2 represents a forward voltage (about 0.7 V) of diode D2.

At time t2, the voltage of clock signal CLK changes from voltage V0 to zero. In response to the change in voltage of clock signal CLK, the voltage of clock signal CLK1 changes from voltage VREG to zero. Therefore, voltage VD1 changes from (VCC+VREG−ΔV1) to (VCC−ΔV1) at time t2.

During a period between times t2 and t3, the voltages of clock signals CLK and CLK1 do not change from those attained at time t1. Likewise, during the period between times t2 and t3, voltage VD1 does not change from the voltage attained at time t1. However, voltage VG lowers during the period between times t2 and t3.

However, capacitor C1 is connected between terminals T1 and T2. Therefore, the rising of voltage VG between times t1 and t2 as well as the lowering of voltage VG between times t2 and t3 occur only to a small extent. Therefore, voltage VG is kept at the voltage higher than voltage VCC.

After time t3, clock signals CLK and CLK1 as well as voltages VD1 and VG repeat the changes similar to those between times t1 and t3. Therefore, description of the changes of clock signals CLK and CLK1 as well as voltages VD1 and VG after time t3 is not repeated.

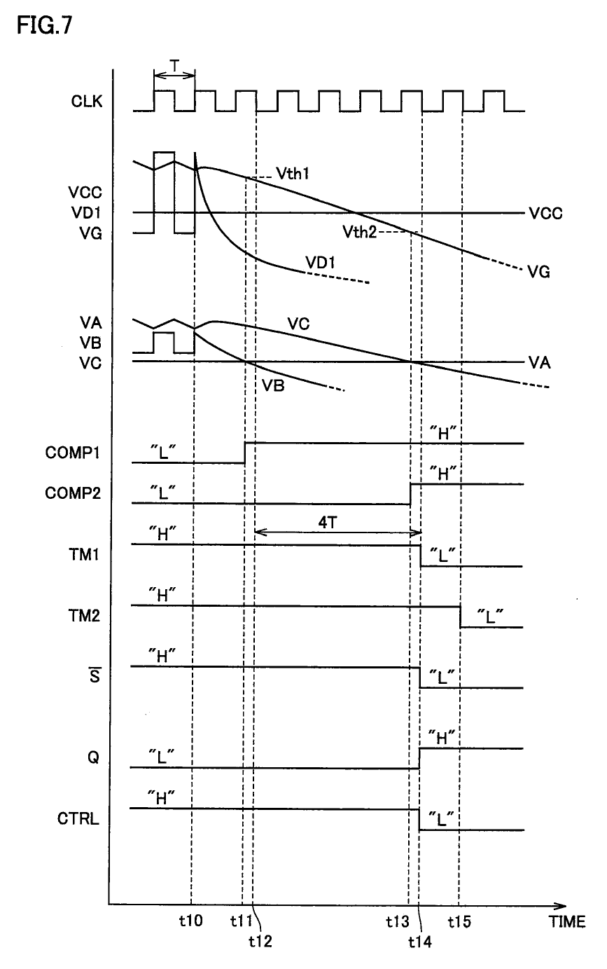

FIG. 7 is a waveform diagram illustrating an operation of switch control circuit 8 in FIG. 5 what is performed when voltage VG in FIG. 2 abnormally lowers. The abnormal lowering of voltage VG occurs, e.g., due to grounding of terminal CP2, grounding of terminal T2 and the like. In this case, voltage VG becomes lower than the lowest value of voltage VG illustrated in FIG. 6.

Referring to FIGS. 7 and 5, both voltages VD1 and VG lower after time t10. Voltage VB lowers with lowering of voltage VD1. Also, voltage VC lowers with lowering of voltage VG. Since voltage VCC is constant, voltage VA is constant.

At time t11, voltage VB becomes lower than voltage VA. Therefore, signal COMP1 changes from the L-level to the H-level at time t11. Voltage VG at time t11 is represented as a voltage Vth1, which corresponds to the “first threshold voltage” in the invention.

At time t12, clock signal CLK changes from the H-level to the L-level. Timer 13 starts the measurement of time elapsed from time t12. Timer 13 changes signal TM1 from the H-level to the L-level at time t14 after 4T from time t12, where T in FIG. 7 represents one period of clock signal CLK.

Further, voltage VG lowers more slowly than voltage VD1. Therefore, voltage VC changes more slowly than voltage VB. At time t13, voltage VC is lower than voltage VA. Therefore, signal COMP2 changes from the L-level to the H-level at time t13. At time t13, voltage VG is equal to a voltage Vth2, which corresponds to a “second threshold voltage” in the invention.

Timer 14 starts the time measurement at time t14 when clock signal CLK falls first after time t13.

At time t14, the signal provided from terminal /S of RS latch 18 changes from the H-level to the L-level. Thereby, the signal provided from terminal Q of RS latch 18 changes from the L-level to the H-level at time t14.

The signal provided from terminal Q of RS latch 18 is supplied to an NOR circuit 19. NOR circuit 19 receives the signal at the L-level from inverter 17 (i.e., it receives the signal produced by inverting the logic level of signal EN). Therefore, signal CTRL changes from the H-level to the L-level at time t14. Thus, the switch shown in FIG. 2 changes from the on state to the off state at time t14. After signal CTRL once changes from the H-level to the L-level, it will keep the L-level.

In summary, timer latch circuit 8B starts the measurement of the elapsed time in response to the change of signal COMP1 from the L-level to the H-level. When the elapsed time exceeds the predetermined time (4T), timer latch circuit 8B changes signal CTRL from the H-level to the L-level, and thereby changes switch SW from the on state to the off state.

When the lowering of voltage VG is larger than the lowering of voltage VG illustrated in FIG. 7, a difference between voltages VCC and VG increases within a short time. In this case, it is preferable for preventing damage to diodes D1 and D2 to minimize the period during which overcurrents flow through diodes D1 and D2.

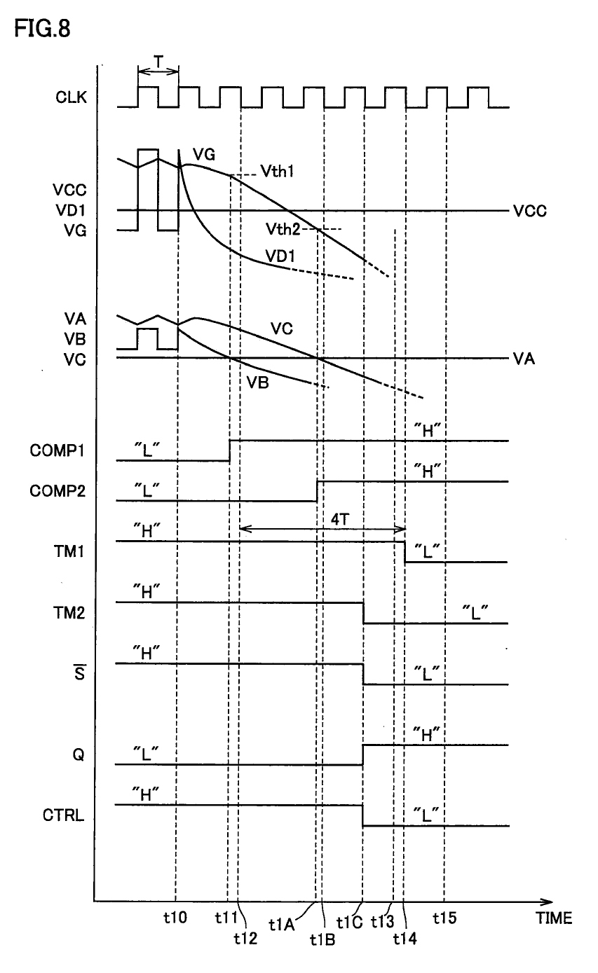

FIG. 8 is another waveform diagram illustrating an operation that is performed by switch control circuit 8 in FIG. 5 when voltage VG lowers.

Referring to FIGS. 8 and 7, the time required for lowering the voltage value of voltage VG from Vth1 to Vth2 in FIG. 8 is shorter than the time required for lowering the voltage value of voltage VG from Vth1 to Vth2 in FIG. 7. In practice, the change in voltage VD1 illustrated in FIG. 8 differs from the change in voltage VD1 illustrated in FIG. 7. However, it is assumed that the change in voltage VD1 in FIG. 8 is equal to that in FIG. 7, for the sake of illustration.

Voltage VG reaches voltage Vth2 at time t1A preceding time t13. Signal COMP2 changes from the L-level to the H-level at time t1A. Timer 14 starts the time measurement at time t1B when first falling of clock signal CLK occurs after time t1A. Signal TM2 changes from the H-level to the L-level at time t1C when first falling of clock signal CLK occurs after time t1B.

At time t1C, the signal provided to terminal /S of RS latch 18 changes from the H-level to the L-level. Thereby, the signal provided from terminal Q of RS latch 18 changes from the L-level to the H-level at time t1C. Therefore, signal CTRL changes from the H-level to the L-level at time t1C preceding time t14.

Thus, timer latch circuit 8B shown in FIG. 5 operates according to signal COMP2, and changes signal CTRL from the H-level to the L-level to turn off switch SW when voltage VC becomes lower than voltage VA during the measurement of the elapsed time from time t12 (i.e., when voltage VC becomes lower than voltage VA at time t1A between times t11 and t14). When voltage VG lowers to a large extent, switch control circuit 8 turns off the switch in a short time after the lowering of voltage VG. Therefore, it is possible to minimize the time during which the overcurrents flow through diodes D1 and D2. Therefore, damage to diodes D1 and D2 can be prevented.

Immediately after booster circuit 2 in FIG. 2 starts the boosting operation, voltage VG is lower than voltage VCC even when booster circuit 2 operates normally. Therefore, switch control circuit 8 may erroneously detect that voltage VG is abnormal, at the start of the operation of booster circuit 2.

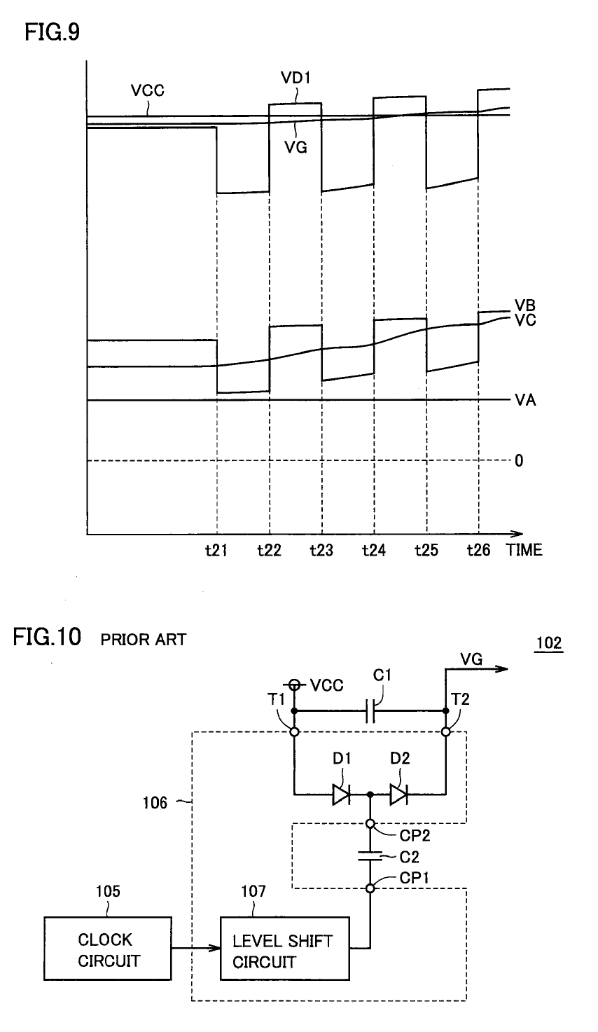

FIG. 9 illustrates operation waveforms at the start of the operation of booster circuit 2 in FIG. 2.

Referring to FIG. 9, the operation starts at time t21. As illustrated in FIG. 9, voltage VD1 is lower than voltage VCC during periods between times t21 and t22, between times t23 and t24, and between times t25 and t26. Voltage VG is lower than voltage VCC during a period between times t21 and t24, and changes to exceed voltage VCC during a period between times t24 and t25.

Resistances R11-R16 shown in FIG. 5 may be configured such that a resistance ratio between resistances R13 and R14 and a resistance ratio between resistances R15 and R16 are equal to that between resistances R11 and R12, in which case voltages VB and VC are lower than voltage VA at the start of the operation of booster circuit 2.

In this embodiment, the resistance ratio between resistances R13 and R14 and the resistance ratio between resistances R15 and R16 are set such that voltages VB and VC are always higher than voltage VA when booster circuit 2 is normally operating. Thus, the resistance ratio between resistances R13 and R14 and the resistance ratio between resistances R15 and R16 are set in view of the lowest values of voltages VD1 and VG. This setting of the resistance ratios means that the first threshold voltage (voltage Vth1) is set lower than voltage VG appearing at the start of the operation of booster circuit 2. Thereby, at the start of the operation of booster circuit 2, switch control circuit 8 is prevented from erroneously determining that voltage VG is abnormal.

This embodiment employs a manner of changing the resistance ratios so that voltages VB and VC may exceed voltage VA. However, another method may be employed and, for example, comparators 11 and 12 may internally give offsets to voltages VB and VC.

According to the embodiment described above, the booster circuit includes the switch between the power supply node and the diode, and includes the control circuit controlling the switch. Thereby, the flow of overcurrents through the diodes can be prevented when the output terminal of the booster circuit is grounded.

Further, according to the embodiment, since the electric device includes the booster circuit having the protection function described above, the reliability of operation can be further increased.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A booster circuit comprising:
a booster boosting a first voltage supplied from a voltage power supply to a first node, and providing the boosted first voltage as a second voltage to a second node;
a switch arranged between said voltage power supply and said first node, and being on at least during an operation of the booster; and
a control circuit monitoring said second voltage during the operation of said booster, and changing said switch from an on state to an off state when said control circuit detects abnormal lowering of said second voltage.

2. The booster circuit according to claim 1, wherein
said control circuit includes:
a detecting unit providing a first detection result indicative of detection of said abnormal lowering when said second voltage becomes lower than a first threshold voltage, and
a switch setting circuit starting measurement of an elapsed time according to said first detection result, and changing said switch from the on state to the off state when said elapsed time exceeds a predetermined time.

3. The booster circuit according to claim 2, wherein
said switch setting circuit stops the measurement of said elapsed time and keeps said switch in the on state when said second voltage rises to or above said first threshold voltage before said elapsed time exceeds said predetermined time.

4. The booster circuit according to claim 2, wherein
said detecting unit provides a second detection result when said detecting unit detects that said second voltage becomes lower than a second threshold voltage lower than said first threshold voltage, and
said switch setting circuit turns off said switch when said switch setting circuit receives said second detection result before said elapsed time exceeds said predetermined time.

5. The booster circuit according to claim 4, further comprising:
a first capacitor connected between said voltage power supply and said second node, and
a second capacitor connected between third and fourth nodes, wherein
said booster includes a first diode having an anode and a cathode connected to said first and third nodes, respectively,
a second diode having an anode and a cathode connected to said third and second nodes, respectively, and
a level shift circuit receiving a clock signal, changing an amplitude of said clock signal and outputting said clock signal to said fourth node; and
said detecting unit includes a first voltage divider circuit dividing said first voltage to produce a first comparison voltage,
a second voltage divider circuit dividing a third voltage on said third node to produce a second comparison voltage,
a third voltage divider circuit dividing said second voltage to produce a third comparison voltage,
a first comparator making a comparison between said first and second comparison voltages to provide a result of the comparison as said first detection result, and
a second comparator making a comparison between said first and third comparison voltages to provide a result of the comparison as said second detection result.

6. The booster circuit according to claim 2, wherein
said first threshold voltage is lower than said second voltage appearing at a start of an operation of said booster.

7. An electric device comprising a booster circuit, wherein
said booster circuit includes:
a booster boosting a first voltage supplied from a voltage power supply to a first node, and providing the boosted first voltage as a second voltage to a second node;
a switch arranged between said voltage power supply and said first node, and being on at least during an operation of the booster; and
a control circuit monitoring said second voltage during the operation of said booster, and changing said switch from an on state to an off state when said control circuit detects abnormal lowering of said second voltage.

8. The electric device according to claim 7, wherein
said control circuit includes:
a detecting unit providing a first detection result indicative of detection of said abnormal lowering when said second voltage becomes lower than a first threshold voltage, and
a switch setting circuit starting measurement of an elapsed time according to said first detection result, and changing said switch from the on state to the off state when said elapsed time exceeds a predetermined time.

9. The electric device according to claim 8, wherein
said switch setting circuit stops the measurement of said elapsed time and keeps said switch in the on state when said second voltage rises to or above said first threshold voltage before said elapsed time exceeds said predetermined time.

10. The electric device according to claim 8, wherein
said detecting unit provides a second detection result when said detecting unit detects that said second voltage becomes lower than a second threshold voltage lower than said first threshold voltage, and
said switch setting circuit turns off said switch when said switch setting circuit receives said second detection result before said elapsed time exceeds said predetermined time.

11. The electric device according to claim 10, wherein
said booster circuit further includes:
a first capacitor connected between said voltage power supply and said second node, and
a second capacitor connected between third and fourth nodes;
said booster includes a first diode having an anode and a cathode connected to said first and third nodes, respectively,
a second diode having an anode and a cathode connected to said third and second nodes, respectively, and
a level shift circuit receiving a clock signal, changing an amplitude of said clock signal and outputting said clock signal to said fourth node; and
said detecting unit includes a first voltage divider circuit dividing said first voltage to produce a first comparison voltage,
a second voltage divider circuit dividing a third voltage on said third node to produce a second comparison voltage,
a third voltage divider circuit dividing said second voltage to produce a third comparison voltage,
a first comparator making a comparison between said first and second comparison voltages to provide a result of the comparison as said first detection result, and
a second comparator making a comparison between said first and third comparison voltages to provide a result of the comparison as said second detection result.

12. The electric device according to claim 8, wherein
said first threshold voltage is lower than said second voltage appearing at a start of an operation of said booster.
